(19) United States
(12) Patent Application Publication
(10) Pub. No.: US 2024/0274034 A1
(43) Pub. Date: Aug. 15, 2024

(54) PHYSICS DEMONSTRATION DEVICE

(71) Applicant: Robert Amirian, Encino, CA (US)

(72) Inventor: Robert Amirian, Encino, CA (US)

(21) Appl. No.: 18/168,403

(22) Filed: Feb. 13, 2023

(51) Int. Cl. G09B 23/10

(52) U.S. Cl. CPC G09B 23/10

(57) ABSTRACT

The present invention is system and method for demonstrating different principles of physics by modifying the design of the original Newton's cradle, wherein the new device may include multiple levels of spheres, spheres that are hanging from suspension fibers of different lengths, spheres that are disposed in an arrangement wherein spheres are not limited to a single linear array but include spheres that are disposed such that arrays of spheres may intersect each other, and spheres that may be used in any of the configurations but may vary in diameter and mass.

### BACKGROUND

### Field of the Invention

This invention relates generally to a device for demonstration of principles of physics. More specifically, the present invention is directed to demonstrating physical principles that can be visualized through movement of suspended stationary and swinging spheres.

### Description of Related Art

The prior art for demonstrating principles of physics includes devices that may be considered as toys or desktop curiosities. Such devices include the famous “Newton's cradle” that has been entertaining students of physics for many years.

The Newton's cradle is a device that demonstrates the conservation of momentum and the conservation of energy with a combination of stationary and swinging spheres. FIG. 1 is a perspective view of a typical Newton's cradle 10 as known in the prior art. The Newton's cradle 10 is comprised of a frame 12 from which hang a plurality of spheres 14. The spheres 14 are shown in a resting state and touching each other. Each of the spheres 14 is suspended from a single string, strand, or suspension fiber 16 such as a monofilament line. The suspension fibers 16 are generally flexible and thin, are comprised of a single fiber, connect each of the spheres 14 to the frame 12, and allow the spheres to hang and swing freely without interference. When the spheres 14 are at rest, there is no movement of the spheres or the suspension fibers 16 and the spheres are generally going to be in contact with any adjacent spheres.

The Newton's cradle 10 is able to demonstrate principles of physics when one or more of the spheres 14 are put in motion. For example, when a first sphere 18 at the end of the row of spheres 14 is lifted and released, it strikes an immediately adjacent stationary sphere, thereby transmitting a force through all of the remaining stationary spheres. As a result of this transfer of force, the last sphere 20 is caused to swing away from the other spheres. After reaching the top of a swinging arc, the last sphere 20 then swings back and strikes the nearly stationary spheres, repeating the transfer of force in the opposite direction.

This operation of the Newton's cradle 10 is illustrated in FIGS. 2A-2D. FIG. 2A shows a total of five spheres 14, with the first sphere 18 being lifted to a position that creates potential energy for the Newton's cradle 10 system. FIG. 2B shows that the first sphere 18 is dropped, allowing the first sphere to swing down toward the other spheres 14 still at rest. FIG. 2C shows the moment that the force or the kinetic energy of the first sphere 18 is transferred to the spheres 14 at rest. Finally, FIG. 2D shows that as a result of the transfer of kinetic energy, a last sphere 20 is now swinging upwards in an arc so that it rises to nearly the height from which the first sphere 18 was dropped.

This process repeats over and over again until all of the kinetic energy of the first sphere 18 in motion is finally lost through the repeated transfer of force and movement and the row of spheres 14 settles down to a resting state without movement. Depending on the materials being used in the Newton's cradle 10 and the efficiency of the transfer of force, it can take a few minutes for all of the kinetic energy to be lost. The difference in time for the kinetic energy to dissipate may depend on several factors and may include but not be limited to physical characteristics of the parts used in the Newton's cradle such as the materials used in the suspension fibers 16, the tension in the suspension fibers, the material used for the spheres 14, the mass of the spheres, the materials used for the frame 12, and the stability of the frame.

The design of the ubiquitous Newton's cradle 10 is well known and relatively unchanged in the many years that it has been used to demonstrate the laws of physics. However, there are other principles of physics that may be demonstrated by devices that are similar to but distinctly different from the original Newton's cradle.

Accordingly, it would be an advantage over the prior art to modify the design of the original Newton's cradle 10 to create new devices that are capable of demonstrating the same and additional principles of physics.

### BRIEF SUMMARY

The present invention is a system and method for demonstrating different principles of physics by modifying the design of the original Newton's cradle, wherein the new device may include multiple levels of spheres, spheres that are hanging from suspension fibers of different length, spheres that are disposed in an arrangement wherein spheres are not limited to a single linear array but include spheres that are disposed such that arrays of spheres may intersect each other, and spheres that may be used in any of the configurations but may vary in diameter and mass.

In a first aspect of the invention, at least two rows of spheres are disposed in multiple vertical levels wherein the suspension fibers are of substantially similar lengths, but other physical characteristics of the spheres vary between the different rows.

In a second aspect of the invention, at least two rows of spheres are disposed in multiple vertical levels wherein the spheres have suspension fibers of substantially different lengths.

In a third aspect of the invention, linear arrays of spheres are disposed such that the arrays intersect each other and have one sphere in common.

In a fourth aspect of the invention, linear arrays of spheres that intersect and share a common sphere may simultaneously have at least one sphere in motion from the different arrays.

In a fifth aspect of the invention, the spheres used in the configurations above may include spheres having different diameters.

In a sixth aspect of the invention, the spheres used in the configurations above may include spheres having the same diameters but having different mass.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a Newton's Cradle device as taught in the prior art.

FIG. 2A is a first diagram showing a sequence of events in raising and then releasing a first sphere in the Newton's Cradle.

FIG. 2B is a second diagram in the sequence of events showing the releasing of the first sphere.

FIG. 2C is a third diagram in the sequence of events showing contact between the first sphere and the resting spheres in the Newton's Cradle.

FIG. 2D is a fourth diagram in the sequence of events showing the transfer of kinetic energy from the first sphere, through the resting spheres, and to a last sphere.

FIG. 3A is a profile view of a first embodiment of the invention.

FIG. 3B is a top view of the first embodiment of the invention.

FIG. 3C is a perspective view of the first embodiment but without the spheres, and thus clearly showing the support frame.

FIG. 3D (1) is one possible shape of a support frame.

FIG. 3D (2) is one possible shape of a support frame.

FIG. 3D (3) is one possible shape of a support frame.

FIG. 3D (4) is one possible shape of a support frame.

FIG. 4A is a profile view of a second embodiment of the invention.

FIG. 4B is a top view of the second embodiment of the invention.

FIG. 5A is a profile view of a third embodiment of the invention.

FIG. 5B is a top view of the third embodiment of the invention.

FIG. 6A is a profile view of a fourth embodiment of the invention.

FIG. 6B is a profile view of the fourth embodiment but illustrating one side of the support frame.

FIG. 7A is a profile view of a fifth embodiment of the invention.

FIG. 7B is a top view of the fifth embodiment of the invention.

FIG. 8A is a top and close-up view of a top surface of a single support frame.

FIG. 8B is a close-up profile view of the end of a single sliding insert inside the hollow support frame.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

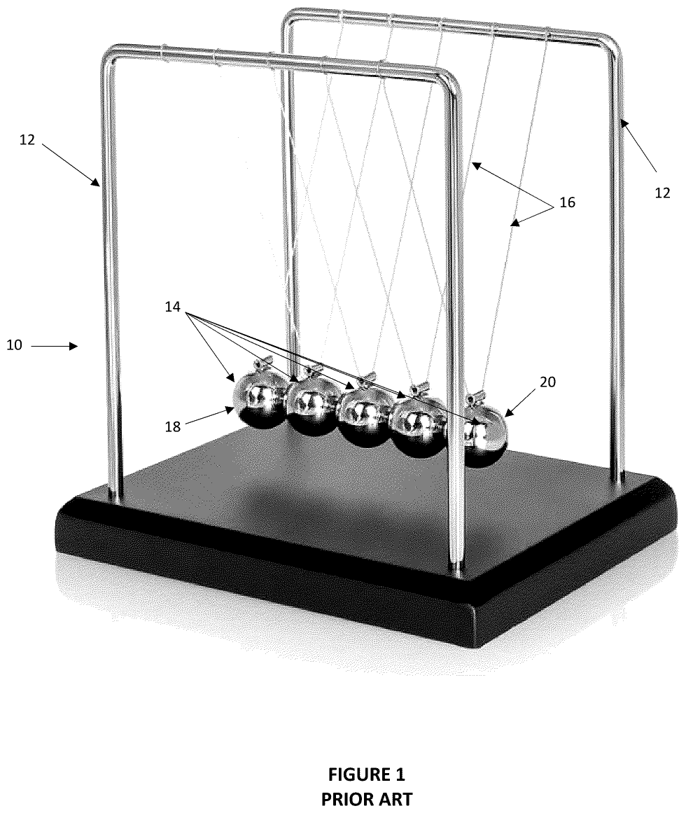

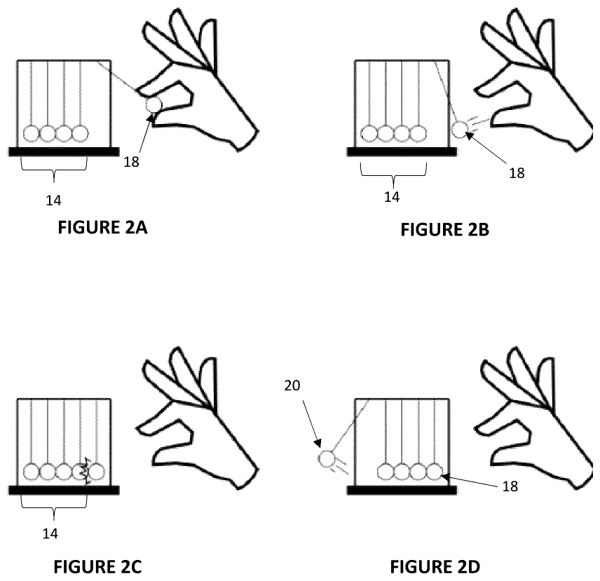

The Newton's cradle 10 shown in FIGS. 1 and 2 is useful to demonstrate the properties of conservation of momentum and conservation of energy with moving spheres. However, there are other arrangements of spheres that may also illustrate the properties of conservation of momentum and conservation of energy and provide additional insights into these properties.

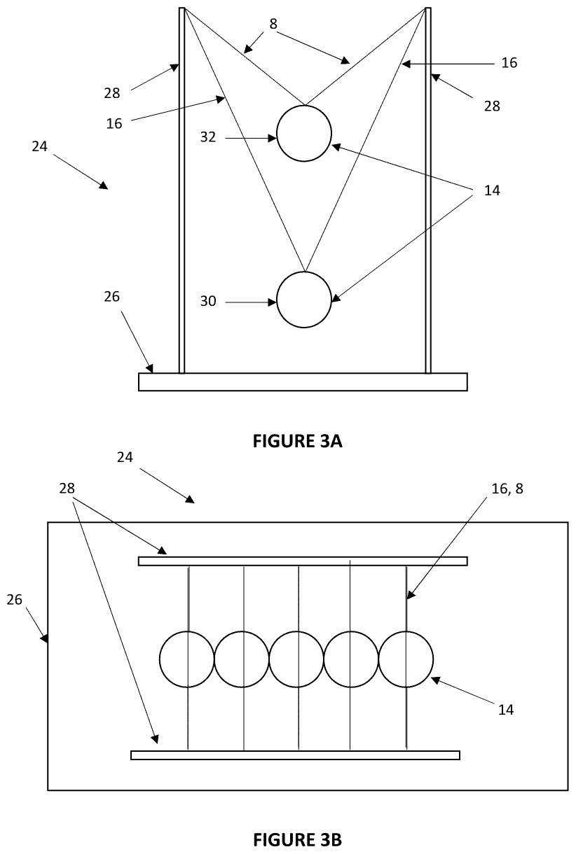

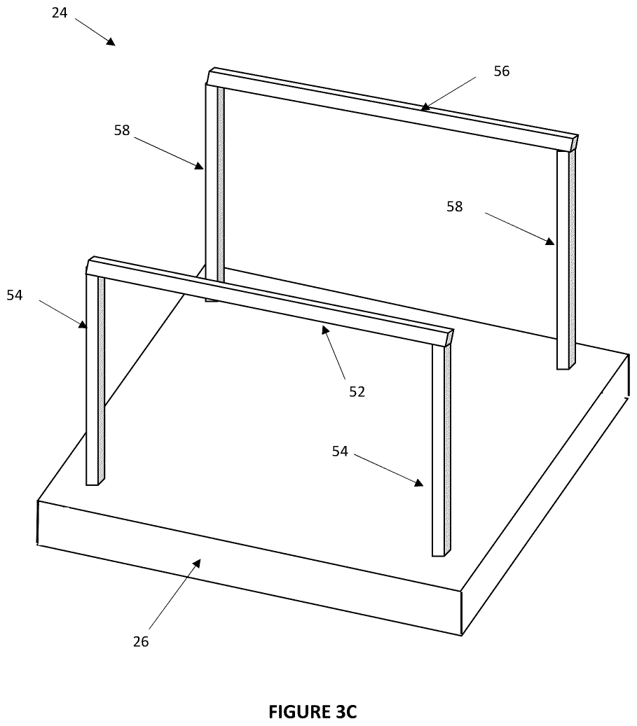

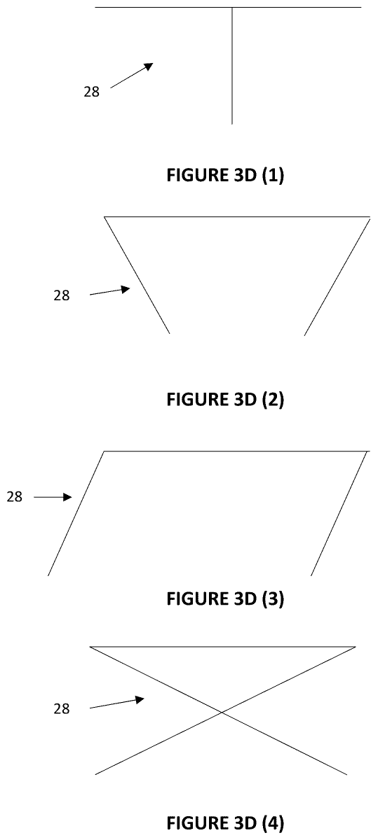

FIG. 3A is a profile view of a first embodiment of the invention as seen from a side view of a modified Newton's cradle or demonstration system 24, such as the base and frame shown in FIG. 1. In this embodiment, a base 26 provides a substrate to which are attached the two support frames 28 of the demonstration system 24. In this first embodiment, there may be a first row 30 and a second row 32 of spheres 14. The first row 30 and the second row 32 are hanging by suspension fibers 16 of different lengths as shown, wherein the suspension fibers 16 of the first row 30 all have a first length and the suspension fibers 16 of the second row 32 all have a second length. In this first embodiment, the diameter, the mass, and the material used to make the spheres 14 are the same in the first row 30 and the second row 32. However, it should be understood that the diameter, the mass, and the material used to make the spheres 14 may be modified and may be different in one row as compared to another row.

The reason for changing the physical characteristics of the demonstration system 24 such as the diameter of the spheres, the mass of the spheres, the material used in the spheres, and the length of the suspension fibers may be to illustrate different aspects of the properties of conservation of momentum and conservation of energy. By varying one or more of these physical characteristics, the user is able to witness a visual demonstration of principles of physics. Alternatively, the user may be able to investigate and make conclusions on their own about the principles of conservation of momentum and conservation of energy before they are explained, and thus the serve as a teaching aid.

Another aspect of the first embodiment of the invention is the ability to change the physical characteristics of the demonstration system 24. By being able to change the physical characteristics, the user may be able to observe the changes in the motion of the spheres.

For example, the user may be able to change the length of the suspension fibers 16 or replace the spheres with spheres having a different diameter, mass, and/or material.

FIG. 3B is a top view of the demonstration system 24 shown in FIG. 3A. FIG. 3B shows the base 26, the support frames 28, the suspension fibers 16, and the second row 32 of the spheres 14. The first row 30 of the spheres 14 is not visible because they are directly beneath and aligned with the spheres of the second row 32.

There may be more than two rows of spheres 14 disposed on the support frames 28. The total number of rows is not relevant with the exception that there be more than one row in the first embodiment. The implication is that the demonstration system 24 of the first embodiment is able to demonstrate different principles of physics by comparing the motion of the different rows.

Another variable that should not affect the scope of the claims of the first embodiment is the number of spheres 14 that are being suspended by the support frames 28. When FIG. 3B shows that five spheres 14 are being used in each row 30, 32 in the first embodiment, this number may vary without affecting the scope of the claims.

FIG. 3C shows a perspective view of the first embodiment without the spheres 14. This figure also shows the base 26 as providing a planar surface. However, it should be understood that the perimeter of the base 26 may have any desired shape. For example, the base could be any elliptical shape, a circle, or any multi-sided shape. Furthermore, the base 26 does not have to be a planar surface as shown here. What is important is that the support frames 28 provide a level plane from which to hang the spheres 14. Accordingly, what is critical is that the support frames 28 provide a level plane, and this may be more easily accomplished by beginning with a level and planar base 26.

The support frames 28 may implement a level reference plane as two support bars that are parallel to each other and with a horizontally level base 26. As shown in FIG. 3C, a first support bar 52 may be disposed over and parallel to the base 26, with at least one first support bar pillar 54 extending from the surface of the base 26 and securing the first support bar to the base. There may also be a second support bar 56 that is parallel to the first support bar 52 and disposed over and parallel to the base 26. It is important that the first support bar 52 be parallel to and level with the second support bar 52 so that the suspension fibers 16 of all of the spheres 14 are of the same length. There may be at least one second support bar pillar 58 extending from the surface of the base 26 and securing the second support bar 56 to the base.

While the first support bar 52 and the second support bar 56 could be supported by a single pillar each that is centered in the middle of each support bar, the demonstration system 24 would be more easily damaged and fail to perform as desired. Two pillars 54, 58 on each of the support bars 52, 56 makes the demonstration system 24 substantially more stable and resistant to damage.

In addition, the four pillars 54, 58 do not have to be perpendicular to the base 26. Each of the four pillars 54, 58 may be disposed at some other angle. However, generally for aesthetic reasons, the four pillars 54, 58 are disposed as shown.

While the two pillars and support bars 52, 56 are shown in this embodiment as being comprised of three separate bars, they may also be combined into a single bar that is bent and shaped into the proper support structure.

In FIGS. 3A and 3B, the first linear array 30 of spheres 14 may be disposed parallel to and over the surface of the base 26, wherein each of the spheres 14 in the first linear array 30 has a first fiber 16 that is coupled to the first support bar 52, the second support bar 56, and one of the spheres in the first linear array, wherein the length of each of the first suspension fibers is of equal length, and wherein each of the spheres is touching each immediately adjacent sphere in the first linear array when the first linear array is at rest.

For proper operation of the demonstration system, the spheres 14 in each linear array are precisely disposed so that each sphere is hanging vertically and without applying a force against any adjacent sphere and is also touching each adjacent sphere. If the spheres 14 are not touching each adjacent sphere when at rest, then energy may be dissipated from the demonstration system 24 when it is put in motion.

In addition, the demonstration system 24 may include a second linear array 32 of spheres 14 disposed parallel to and over the surface of the base 26, wherein each of the second linear array of spheres has a second support fiber 8 that is coupled to the first support bar 52, the second support bar 56, and one of the spheres in the second linear array, wherein the length of each of the second suspension fibers 8 is of equal length, and wherein each of the spheres is touching each immediately adjacent sphere in the second linear array when the second linear array is at rest.

In this first embodiment, the length of the first suspension fibers 16 is greater than the length of the second suspension fibers 8 such that the first linear array 30 of spheres 14 is disposed in alignment with and directly under and parallel to the second linear array 32 of spheres, and wherein the first linear array and the second linear array are free to swing in an arc defined by the first suspension fibers and the second suspension fibers, respectively.

FIGS. 3D(1), (2), (3), (4) are provided as a plurality of shapes that may all be used as support frames 28 for the spheres of the demonstration system 24. The shapes of the support frames 28 are all shown as profile images. It should be understood that the support frames 28 images are only examples of possible support structure shapes and other shapes may be used that also fall within the claimed invention. These are given as examples only to illustrate the fact that the support frames 28 may have many different shapes that fall within the scope of the claimed invention.

The support frames 28 may be a single piece of material such as metal, or it may be constructed of multiple individual pieces that are attached to each other in the desired shape. The support frames 28 formed of a single piece of material or from multiple pieces coupled together should both fall within the scope of the claims, and thus all of the embodiments of the invention disclosed herein should be considered to be formed as a single piece or from multiple pieces of material.

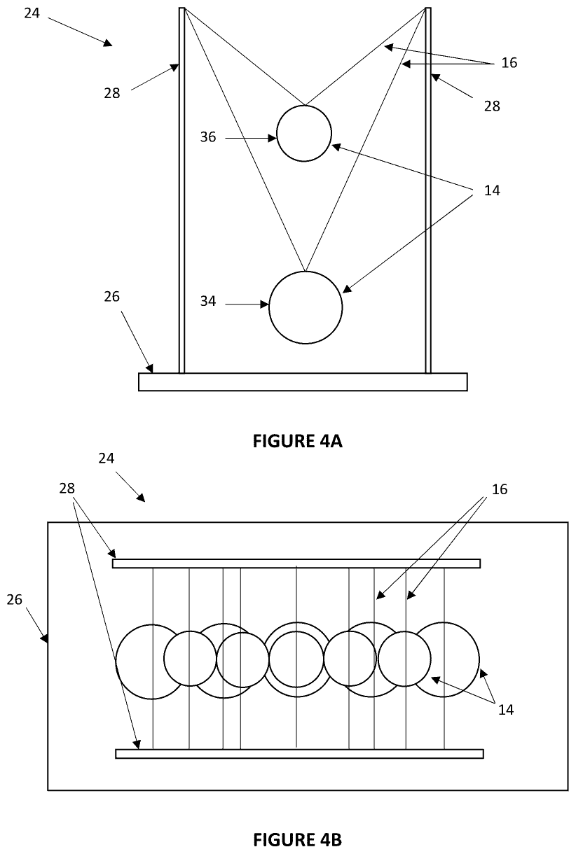

FIG. 4A is a profile view of a second embodiment of the invention as seen from a side of the demonstration system 24, such as the base and frame shown in FIG. 1. In this embodiment, the base 26 provides a platform to which are attached the support frames 28 of the demonstration system 24.

In this second embodiment, there may be a first row 34 and a second row 36 of spheres 14. The first row 34 and the second row 36 are hanging by suspension fibers 16 of different lengths as shown. In this second embodiment, the diameter of the spheres 14 is different between the first row 34 and the second row 36 of spheres. However, the mass, and the material used to make the spheres 14 are the same in the first row 34 and the second row 36. However, it should be understood that the mass and the material used to make the spheres 14 may be changed. Furthermore, while the diameter of the spheres 14 in the first row 34 are shown as larger than the spheres 14 in the second row 36, the diameter of the spheres may be switched with the larger diameter spheres on the second row 36.

The reason for changing the physical characteristics of the spheres 14 such as the mass, the diameter, and the material used in the spheres may be to illustrate different aspects of the properties of conservation of momentum and conservation of energy. By varying one or more of these physical characteristics, the user is able to witness the principles that are being explained. Alternatively, the user may be able to investigate and make conclusions on their own about properties of conservation of momentum and conservation of energy before they are explained.

FIG. 4B is a top view of the demonstration system 24 shown in FIG. 4A. FIG. 4B shows the base 26, the support frames 28, the suspension fibers 16, the first row 34 and the second row 36 of the spheres 14. The first row 34 of the spheres 14 is visible because the spheres have a larger diameter than the spheres of the second row 36. Another difference is that the suspension fibers 16 are no longer aligned because of the difference in the diameter of the spheres 14 in the different rows 34, 36. The suspension fibers 16 will always be aligned vertically with a diameter of the sphere 14 to which they are connected.

It is noted that there may be more than two rows of spheres 14 disposed on the support frames 28. The number of rows is not important except for the requirement that there be more than one row of spheres in the second embodiment.

Another variable that should not affect the scope of the claims of the second embodiment is the number of spheres 14 that are being suspended by the support frames 28. When FIG. 4B shows that five spheres 14 are being used in each row 34, 36 in the second embodiment, this number may vary without affecting the scope of the claims. However, generally there will always be more than three spheres in each row.

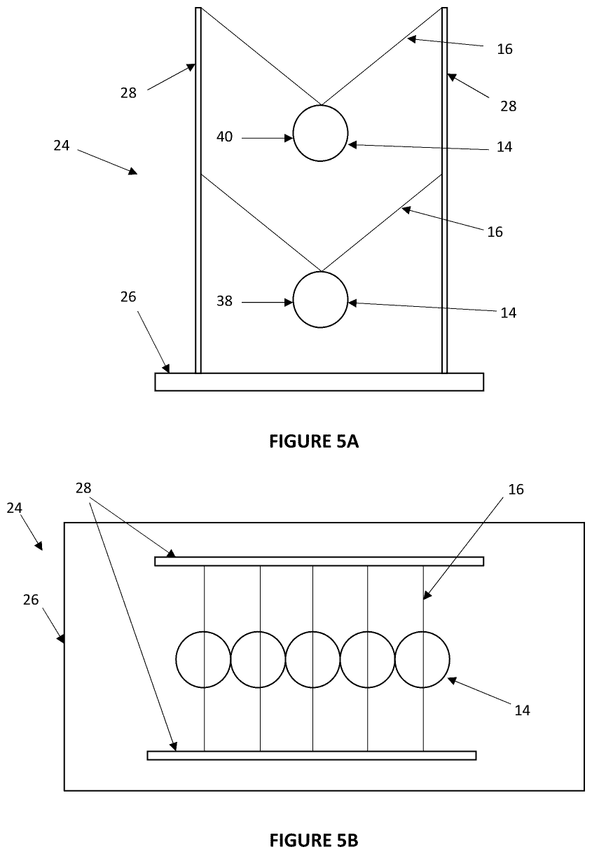

FIG. 5A is a profile view of a third embodiment of the invention as seen from a side of the demonstration system 24, such as the base and frame shown in FIG. 1. In this embodiment, the base 26 provides a platform to which are attached the support frames 28 of the demonstration system 24. In this third embodiment, there may be a first row 38 and a second row 40 of spheres 14. The first row 38 and the second row 40 are hanging by suspension fibers 16 of substantially the same length as shown. In this third embodiment, the diameter and the material used to make the spheres 14 are the same in the first row 38 and the second row 40. However, the diameter and the material used to make the spheres 14 in the different rows may vary.

In this third embodiment, the mass of the spheres 14 of the first row 38 is different from the mass of the spheres in the second row 40. For example, the mass of the first row 38 of spheres 14 may be greater than the mass of the second row 40 of spheres. This change in mass will result in an identifiable change in motion between the first row 38 and the second row 40 of spheres 14 because of the properties of conservation of momentum and conservation of energy.

FIG. 5B is a top view of the demonstration system 24 shown in FIG. 5A. FIG. 5B shows the base 26, the support frames 28, the suspension fibers 16, and the second row 40 of the spheres 14. The first row 38 of the spheres 14 is not visible because they are directly beneath and aligned with the spheres of the second row 40.

It is also noted that there may be more than two rows of spheres 14 disposed on the support frames 28 in the third embodiment. The number of rows is not important except for the requirement that there be more than one row in the third embodiment.

Another variable that should not affect the scope of the claims of the first embodiment is the number of spheres 14 that are being suspended by the support frames 28. When FIG. 5B shows that five spheres 14 are being used in each row 38, 40 in the third embodiment, this number may vary without affecting the scope of the claims.

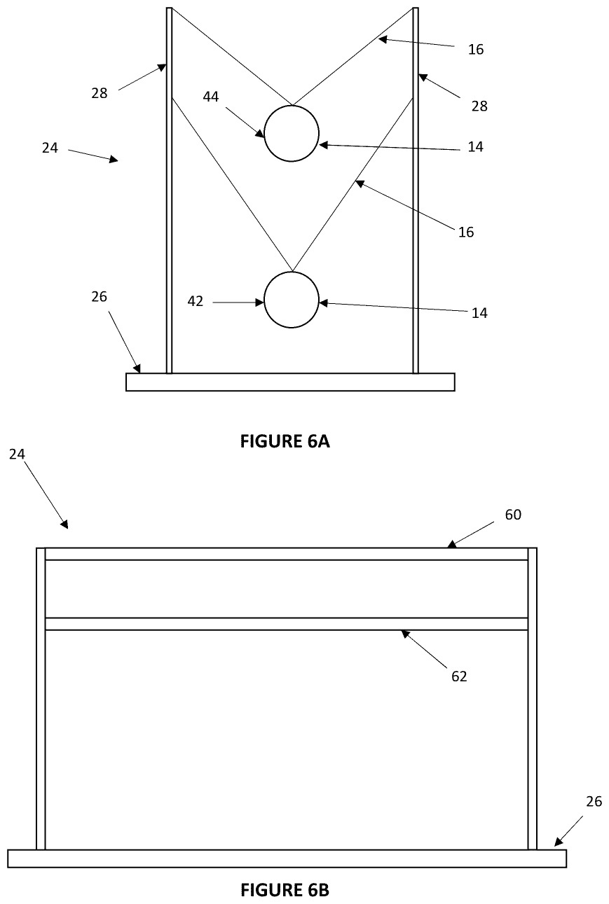

FIG. 6A is a profile view of a fourth embodiment of the invention as seen from a side of the demonstration system 24, such as the base and frame shown in FIG. 1. In this embodiment, the base 26 provides a substrate to which are attached the support frames 28 of the demonstration system 24. In this fourth embodiment, there may be a first row 42 and a second row 44 of spheres 14. The first row 42 and the second row 44 hanging by suspension fibers 16 of different lengths as shown. However, a difference between this fourth embodiment and the first embodiment is that the suspension fibers 16 are not attached to a same location on the support frames 28. The suspension fibers 16 are attached to two different support bars 60, 62 (shown in FIG. 6B) on each of the frames 28.

In addition, the diameter and the material used to make the spheres 14 are the same in the first row 42 and the second row 44. However, the diameter, the mass, and the material used to make the spheres 14 may be changed.

In this embodiment, a difference between the spheres 14 of the first row 42 and the second row 44 is the mass of the spheres. For example, the mass of the first row 42 of spheres 14 may be greater than the mass of the second row 44 of spheres. This change will result in an identifiable change in motion between the first row 42 and the second row 44 because of the properties of conservation of momentum and conservation of energy.

FIG. 6B is a profile view turned 90 degrees horizontally with respect to FIG. 6A. This figure shows that there are two supports bars 60, 62 on each of the support frames 28 from which the first row 42 and the second row of spheres 14 are hanging. The first support bar 60 is parallel with the second support bar 62 and parallel with the base 26.

In an alternative embodiment, additional support bars could be disposed on the support frames 28. Thus, any number of rows of support bars may be disposed on each side of the support frames 28.

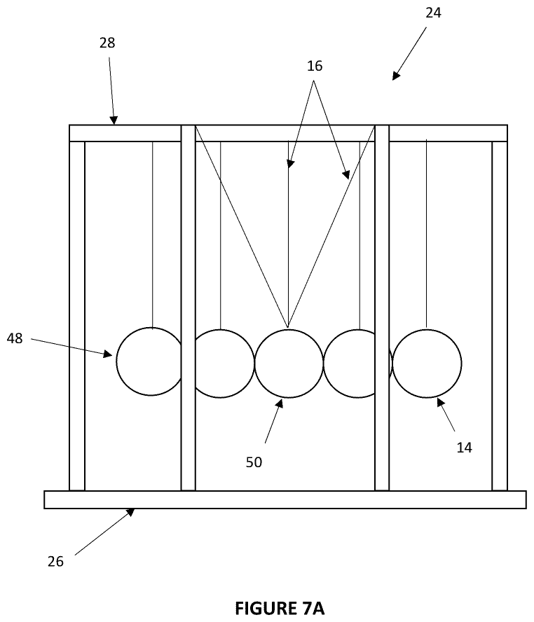

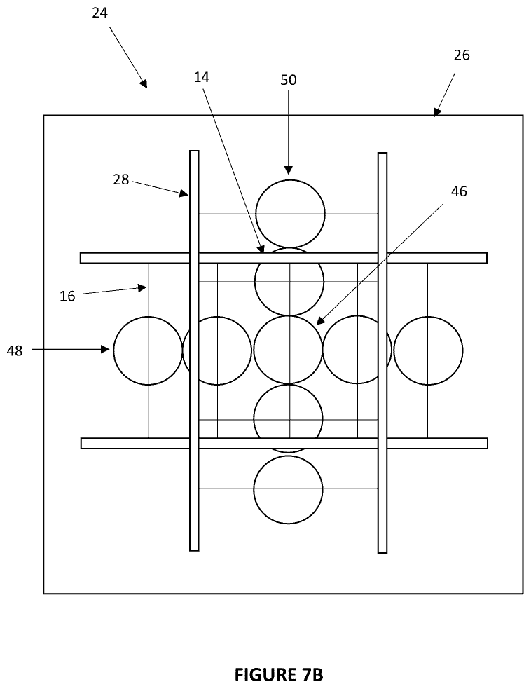

FIG. 7A is a profile view of a fifth embodiment of the invention. However, unlike the other embodiments of the invention shown thus far, this fifth embodiment does not present a “side” view of the demonstration system 24. Instead, this fifth embodiment is created so that the profile of all four sides looks the same. Furthermore, the base 26 is substantially in the shape of a square, thereby making the demonstration system 24 appear as a uniform structure from all four sides.

The base 26 provides a platform to which are attached the support frames 28 of the demonstration system 24. In this fifth embodiment, there may be two rows of spheres 14. However, the two rows of spheres 14 may be disposed as two intersecting linear arrays of spheres, with an odd number of spheres (in this embodiment, five spheres) disposed in each linear array, and a center sphere 46 (shown in FIG. 7B) of each of the intersecting linear arrays being a sphere that is common to both arrays. Thus, the fifth embodiment may be comprised of a first linear array 48 and a second linear array 50 that are disposed perpendicular to each other and intersecting but in a same horizontal plane.

In this fifth embodiment, the diameter and the material used to make the spheres 14 are the same in the first linear array 48 and the second linear array 50. However, the diameter and the material used to make the spheres 14 may be changed.

FIG. 7B is a top view of the demonstration system 24 shown in FIG. 7A. FIG. 7B shows the base 26, the support frames 28, the suspension fibers 16, the first linear array 48 of spheres 14, and the second linear array 50 of spheres, with a common center sphere 46 disposed in the center of the linear arrays.

One particular physical characteristic of the demonstration system 24 in the fifth embodiment may be the angle at which the first linear array 48 and the second linear array 50 meet at the center sphere 46. In an alternative of the fifth embodiment, the first linear array 48 and the second linear array 50 may meet at the center sphere 46 at something other than a perpendicular angle. For example, the angle between the first linear array 48 and the second linear array 50 may be 45 degrees and 135 degrees. What is important is that the angle between the first linear array 48 and the second linear array 50 does not affect the scope of the claims.

Another variable that should not affect the scope of the claims of the fifth embodiment is the number of spheres 14 that are being suspended by the support frames 28. Although five spheres 14 are shown in each of the linear arrays 48, 50, this number may vary without affecting the scope of the claims.

In a final aspect of the invention, it is possible to enable the position of the spheres 14 to be changed relative to the support frames 28. In other words, in some of the embodiments, the spheres 14 may be suspended from suspension fibers 16 that may slide up and down on the top of the support frames 28.

The purpose of such a modification to the support frames is to enable experimentation with the spheres 14. For example, making adjustments to the spacing of the suspension fibers 16 will cause adjacent spheres 14 to not hang vertically next to each other but to instead “lean” against adjacent spheres which will alter the motion of the spheres and the speed with which kinetic energy is lost.

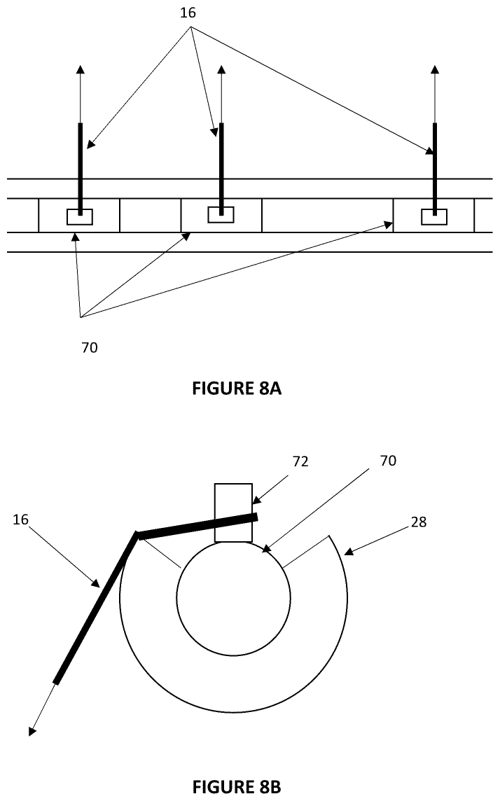

FIG. 8A is a top and close-up view of a top surface of a single support frame 28. The support frame 28 may be a hollow structure at least on the top of the support frame and which allows friction fit objects to slide inside the support frame. FIG. 8A shows three different sliding inserts 70 that slide within the hollow support frame 28. The sliding inserts 70 do not move within the support frame 28 unless they are pushed with an external force such as a pen tip or other object. In that way, the sliding inserts 70 will not be caused to move from the motion of the spheres 14 alone.

Each of the sliding inserts 70 also has attached to it one of the suspension fibers 16 that are suspending the spheres 14.

FIG. 8B is a cut-away profile view of a single one of the sliding inserts 70 as seen from an end and within the support frame 28. In this embodiment, the sliding insert includes a post 72 to which the suspension fiber 16 is attached. By providing movable sliding inserts 70, the user is able to modify the characteristics of the demonstration system 24 by creating tension between adjacent spheres 14 or creating gaps between spheres that will dissipate kinetic energy.

In summary, one embodiment of the present invention is a demonstration system for displaying movement of spheres in an arc, said system comprised of a base providing a planar surface, a first support frame that is coupled to the base and extends upwards from the base to form a first linear support bar that is parallel to the base, a second support frame that is coupled to the base and extends upwards from the base to form a second linear support bar that is parallel to the base and parallel to the first support bar, wherein the first support bar and the second support bar are also of equal length and are spaced apart from each other, a first linear array of spheres disposed parallel to and over the surface of the base, wherein each of the first linear array of spheres has a first fiber that is coupled to the first linear support bar, the second linear support bar, and one of the spheres in the first linear array, wherein the length of each of the first suspension fibers is of equal length, and wherein each of the spheres is touching each immediately adjacent sphere in the first linear array when the first linear array is at rest, a second linear array of spheres disposed parallel to and over the surface of the base, wherein each of the second linear array of spheres has a second fiber that is coupled to the first linear support bar, the second linear support bar, and one of the spheres in the second linear array, wherein the length of each of the second suspension fibers is of equal length, and wherein each of the spheres is touching each immediately adjacent sphere in the second linear array when the second linear array is at rest, and wherein the length of the first suspension fibers is greater than the length of the second suspension fibers such that the first linear array of spheres is disposed directly under and parallel to the second linear array of spheres, and wherein the first linear array and the second linear array of spheres are free to swing in an arc defined by the first suspension fibers and the second suspension fibers.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A demonstration system for displaying movement of spheres in an arc, said system comprised of:
a base providing a planar surface;
a first support frame that is coupled to the base and extends upwards from the base to form a first linear support bar that is parallel to the base;
a second support frame that is coupled to the base and extends upwards from the base to form a second linear support bar that is parallel to the base and parallel to the first support bar, wherein the first support bar and the second support bar are also of equal length and are spaced apart from each other;
a first linear array of spheres disposed parallel to and over the surface of the base, wherein each of the first linear array of spheres has a first fiber that is coupled to the first linear support bar, the second linear support bar, and one of the spheres in the first linear array, wherein the length of each of the first suspension fibers is of equal length, and wherein each of the spheres is touching each immediately adjacent sphere in the first linear array when the first linear array is at rest;
a second linear array of spheres disposed parallel to and over the surface of the base, wherein each of the second linear array of spheres has a second fiber that is coupled to the first linear support bar, the second linear support bar, and one of the spheres in the second linear array, wherein the length of each of the second suspension fibers is of equal length, and wherein each of the spheres is touching each immediately adjacent sphere in the second linear array when the second linear array is at rest; and
wherein the length of the first suspension fibers is greater than the length of the second suspension fibers such that the first linear array of spheres is disposed directly under and parallel to the second linear array of spheres, and wherein the first linear array and the second linear array of spheres are free to swing in an arc defined by the first suspension fibers and the second suspension fibers.

2. The demonstration system as defined in claim 1 wherein the demonstration system further comprises the first linear array of spheres being comprised of spheres having a same mass and diameter as the second linear array of spheres.

3. The demonstration system as defined in claim 1 wherein the demonstration system further comprises the first linear array of spheres being comprised of spheres having a same mass but different diameter as the second linear array of spheres.

4. The demonstration system as defined in claim 1 wherein the demonstration system further comprises the first linear array of spheres being comprised of spheres having a different mass but a same diameter as the second linear array of spheres.

5. The demonstration system as defined in claim 1 wherein the demonstration system further comprises the first linear array of spheres being comprised of spheres having a material that is different from the second linear array.

6. The demonstration system as defined in claim 1 wherein the demonstration system further comprises the number of spheres in the first linear array of spheres being equal to the number of spheres in the second linear array of spheres, and wherein there are at least three spheres in each of the linear array of spheres.

7. The demonstration system as defined in claim 1 wherein the demonstration system further comprises:
the first linear support bar and the second linear support bar are hollow and are open on a top edge thereof; and
a plurality of sliding inserts disposed in the first linear support bar and the second linear support bar, wherein the sliding inserts are friction fit so that a force must be applied to each of the sliding inserts to cause them to slide along the length of the first linear support bar and the second linear support bar, and wherein the suspension fibers are attached to the sliding inserts.

8. The demonstration system as defined in claim 1 wherein the demonstration system further comprises:
a third linear array of spheres disposed parallel to and over the surface of the base, wherein each of the third linear array of spheres has a third fiber that is coupled to the first support bar, the second support bar, and one of the spheres in the third linear array, wherein the length of each of the third suspension fibers is of equal length, and wherein each of the spheres is touching each immediately adjacent sphere in the third linear array when the third linear array is at rest; and
wherein the length of the third suspension fibers is less than the length of the second suspension fibers such that the second linear array of spheres is disposed directly under and parallel to the third linear array of spheres, and wherein the third linear array is free to swing in an arc defined by the third suspension fibers.

9. A demonstration system for displaying movement of spheres in an arc, said system comprised of:
a base providing a planar surface;
a first support bar disposed over and parallel to the base;
a second support bar disposed over and parallel to the base, and disposed directly under the first support bar;
at least one first pillar extending from the surface of the base and securing the first support bar and the second support bar to the base;
a third support bar of equal length to the first support bar and disposed over and parallel to the base at a same height as the first support bar, the third support bar also being parallel to the first support bar;
a fourth support bar disposed over and parallel to the base, and disposed directly under the third support bar and at a same height as the second support bar;
at least one second pillar extending from the surface of the base and securing the third support bar and the fourth support bar to the base;
a first linear array of spheres disposed parallel to and over the surface of the base, wherein each of the first linear array of spheres has a first fiber that is coupled to the second support bar, the fourth support bar, and one of the spheres in the first linear array, wherein the length of each of the first suspension fibers is of equal length, and wherein each of the spheres is touching each immediately adjacent sphere in the first linear array when the first linear array is at rest;
a second linear array of spheres disposed parallel to and over the surface of the base, wherein each of the second linear array of spheres has a second fiber that is coupled to the first support bar, the third support bar, and one of the spheres in the second linear array, wherein the length of each of the second suspension fibers is of equal length, and wherein each of the spheres is touching each immediately adjacent sphere in the second linear array when the second linear array is at rest; and
wherein the length of the first suspension fibers is greater than the length of the second suspension fibers such that the first linear array of spheres is disposed directly under, in alignment with, and parallel to the second linear array of spheres, and wherein the first linear array and the second linear array are free to swing in an arc defined by the first suspension fibers and the second suspension fibers.

10. The demonstration system as defined in claim 9 wherein the demonstration system further comprises the first linear array of spheres being comprised of spheres having a same mass and diameter as the second linear array of spheres.

11. The demonstration system as defined in claim 9 wherein the demonstration system further comprises the first linear array of spheres being comprised of spheres having a same mass but different diameter as the second linear array of spheres.

12. The demonstration system as defined in claim 9 wherein the demonstration system further comprises the first linear array of spheres being comprised of spheres having a different mass but a same diameter as the second linear array of spheres.

13. The demonstration system as defined in claim 9 wherein the demonstration system further comprises the first linear array of spheres being comprised of spheres having a material that is different from the second linear array of spheres.

14. The demonstration system as defined in claim 9 wherein the demonstration system further comprises:
a fifth support bar of equal length to the first support bar and disposed over and parallel to the base and below the second first support bar, the fifth support bar also being parallel to the first support bar;
a sixth support bar disposed over and parallel to the base, and disposed directly under the fourth support bar and at a same height as the fifth support bar;
a third linear array of spheres disposed parallel to and over the surface of the base, wherein each of the third linear array of spheres has a third fiber that is coupled to the fifth support bar, the sixth support bar, and one of the spheres in the third linear array, wherein the length of each of the third suspension fibers is of equal length, and wherein each of the spheres is touching each immediately adjacent sphere in the third linear array when the third linear array is at rest; and
wherein the length of the third suspension fibers is less than the length of the second suspension fibers such that the second linear array of spheres is disposed directly under and parallel to the third linear array of spheres, and wherein the third linear array is free to swing in an arc defined by the third suspension fibers.

15. A demonstration system for displaying movement of spheres in an arc, said system comprised of:
a base providing a planar surface;
a first and a second support bar disposed over and parallel to the base, wherein the first and the second support bars are parallel to each other and of equal length, and are separated from each other by a first width;
a third and a fourth support bar disposed over and parallel to the base, wherein the third and the fourth support bars are parallel to each other and of equal length, and are separated from each other by the first width;
wherein the first and second support bars are in a same plane as the third and fourth support bars, and perpendicular to each other, and wherein they are arranged so as to appear as a hashtag symbol when viewed from above;
at least one first pillar extending from the surface of the base and securing the first support bar to the base;
at least one second pillar extending from the surface of the base and securing the second support bar to the base;
at least one third pillar extending from the surface of the base and securing the third support bar to the base;
at least one fourth pillar extending from the surface of the base and securing the fourth support bar to the base;
a first linear array of spheres disposed parallel to and over the surface of the base, wherein each of the first linear array of spheres has a first fiber that is coupled to the first support bar, the second support bar, and one of the spheres in the first linear array, wherein the length of each of the first suspension fibers is of equal length, and wherein each of the spheres is touching each immediately adjacent sphere in the first linear array when the first linear array is at rest;
a second linear array of spheres disposed parallel to and over the surface of the base, wherein each of the second linear array of spheres has a second fiber that is coupled to the third support bar, the fourth support bar, and one of the spheres in the second linear array, wherein the length of each of the second suspension fibers is of equal length, and wherein each of the spheres is touching each immediately adjacent sphere in the second linear array when the second linear array is at rest; and
wherein the first linear array and the second linear array have a same number and odd number of spheres and share a center sphere.

16. The demonstration system as defined in claim 15 wherein the demonstration system further comprises the first linear array of spheres being comprised of spheres having a same mass and same diameter as the second linear array of spheres.

17. The demonstration system as defined in claim 15 wherein the demonstration system further comprises the first linear array of spheres being comprised of spheres having a different mass but a same diameter as the second linear array of spheres.

18. A method for displaying movement of spheres in an arc, said method comprised of:
providing a plurality of spheres suspended in a first linear array, wherein each of the plurality of spheres is suspended from a separate first suspension fiber that is coupled to two parallel support bars, wherein the first linear array is disposed in a horizontal arrangement, wherein the length of each of the first suspension fibers is of equal length, and wherein each of the spheres is touching each immediately adjacent sphere when the first linear array is at rest;
providing a plurality of spheres suspended in a second linear array, wherein each of the plurality of spheres is suspended from a separate second suspension fiber that is coupled to the two parallel support bars, wherein the second linear array is disposed in a horizontal arrangement, wherein the length of each of the second suspension fibers is of equal length, and wherein each of the spheres is touching each immediately adjacent sphere when the second linear array is at rest;
disposing the first linear directly aligned with and under the second linear array by making the length of the first suspension fibers greater than the length of the second suspension fibers;
pulling on one or more spheres from one end of the first linear array of spheres so that at least one sphere is raised above the remaining spheres of the first linear array by moving in an arc motion as defined by the first suspension fibers; and
releasing the at least one sphere of the first linear array of spheres that was raised so that it strikes the remaining spheres of the first linear array of spheres.

19. The method as defined in claim 18 wherein the method further comprises pulling on one or more spheres from one end of the second linear array of spheres so that at least one sphere is raised above the remaining spheres of the second linear array of spheres by moving in an arc motion as defined by the second suspension fibers; and
releasing the at least one sphere of the second linear array of spheres that was raised so that it strikes the remaining spheres of the second linear array of spheres.

20. A demonstration system for displaying movement of spheres in an arc, said system comprised of:
a base providing a planar surface;
a first support bar disposed over and parallel to the base;
at least one first support bar pillar extending from the surface of the base and securing the first support bar to the base;
a second support bar of equal length to the first support bar and disposed over and parallel to the base, the second support bar also being parallel to the first support bar;
at least one second support bar pillar extending from the surface of the base and securing the second support bar to the base;
a first linear array of spheres disposed parallel to and over the surface of the base, wherein each of the first linear array of spheres has a first fiber that is coupled to the first support bar, the second support bar, and one of the spheres in the first linear array, wherein the length of each of the first suspension fibers is of equal length, and wherein each of the spheres is touching each immediately adjacent sphere in the first linear array when the first linear array is at rest;
a second linear array of spheres disposed parallel to and over the surface of the base, wherein each of the second linear array of spheres has a second fiber that is coupled to the first support bar, the second support bar, and one of the spheres in the second linear array, wherein the length of each of the second suspension fibers is of equal length, and wherein each of the spheres is touching each immediately adjacent sphere in the second linear array when the second linear array is at rest; and
wherein the length of the first suspension fibers is greater than the length of the second suspension fibers such that the first linear array of spheres is disposed directly under and parallel to the second linear array of spheres, and wherein the first linear array and the second linear array are free to swing in an arc defined by the first suspension fibers and the second suspension fibers.
